(19) United States
(12) Patent Application Publication
(10) Pub. No.: US 2015/0215389 A1
(43) Pub. Date: Jul. 30, 2015

(54) DISTRIBUTED SERVER ARCHITECTURE

(71) Applicant: salesforce.com, inc., San Francisco, CA (US)

(72) Inventor: Barry SPENCER, Falmouth, ME (US)

(21) Appl. No.: 14/565,050

(22) Filed: Dec. 9, 2014

Related U.S. Application Data
(60) Provisional application No. 61/933,378, filed on Jan. 30, 2014.

(51) Int. Cl. H04L 29/08; G06F 17/30

(52) U.S. Cl. CPC H04L 67/1002; G06F 17/30321; G06F 17/30097; H04L 67/06

(57) ABSTRACT

A database system includes media servers and file servers. The media servers may establish network connections with clients and receive file requests over the network connections. The media servers then may use an indexing scheme to distribute the file requests to the file servers. The media servers may reduce the amount of connection handshaking by receiving multiple file requests over the same client connections. The media servers also may detect file server failures and dynamically reassign file requests to other operating file servers. The unique configuration of media servers and file servers enable the database system to load balance client connections while also maintaining file associations with particular file servers.

### CLAIM OF PRIORITY

This application claims the benefit of U.S. Provisional Patent Application 61/933,378 entitled SYSTEM AND METHOD FOR SYNCHRONIZATION OF FILES, by Barry Spencer et al., filed Jan. 30, 2014 (Attorney Docket No. 1331PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. patent application Ser. No. 13/648,777, entitled SLIPSTREAM BANDWIDTH MANAGEMENT ALGORITHM, by Barry Spencer, filed Oct. 10, 2012, Attorney Docket No. 8956P091 (783US).

### TECHNICAL FIELD

One or more implementations relate to processing files in a database system, and more specifically to a distributed server architecture for processing file requests.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows a system diagram for an example server architecture according to some implementations.

FIG. 4 shows the system diagram of FIG. 3 and example interconnections between different servers according to some implementations.

FIG. 5 shows a block diagram illustrating an example indexing scheme according to some implementations.

FIG. 6 shows a block diagram illustrating the example indexing scheme of FIG. 5 operating during a server failure according to some implementations.

FIG. 7 shows a block diagram illustrating another example of the indexing scheme of FIG. 5 operating during a server failure according to some implementations.

FIG. 8 shows an operational flow diagram illustrating an example client technique for sending file requests according to some implementations.

FIG. 9 shows an operational flow diagram illustrating an example media server technique for processing file requests according to some implementations.

FIG. 10 shows an operational flow diagram illustrating another example media server technique for processing file requests during a server failure according to some implementations.

FIG. 11 shows an operational flow diagram illustrating an example file server technique for processing file requests according to some implementations.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

File servers may store files for a customer relationship management system, media sharing system, cloud storage system, or any other type of file storage system. A client device may periodically synchronize files with the file servers by uploading updated files and/or new files to the file servers and/or downloading updated files and/or new files from the file servers. However, establishing a connection to each of the file servers for synchronization may be an expensive use of system resources, and time-consuming as each server handshakes and authenticates the requesting client.

A media server receives file requests from the client device to access a first file and a second file. For example, the media server may receive a request for an account record from a mobile phone, and the request may indicate that the mobile phone has recently created a new contact record.

The media server identifies a first file server that accesses the first file and is in communication with the media server, and a second file server that accesses the second file and is in communication with the media server. For example, the media server may identify a first file server A as storing the requested account record and file server B as the intended server for storing a new contact record, where the media server has already established connections to file server A and file server B.

The media server enables the client to access the first file via the first file server and to access the second file via the second file server. For example, the media server enables the mobile phone to download the account record from file server A and to upload the new contact record to file server B.

The client device may initiate multiple file requests over the same connection with the media server for high speed synchronization of files. The media server's existing connections with the file servers eliminate the resource cost of establishing and tearing down multiple connections with the file servers.

In some implementations, the users described herein are users (or “members”) of an interactive online “enterprise social network,” also referred to herein as an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### I. Example System Overview

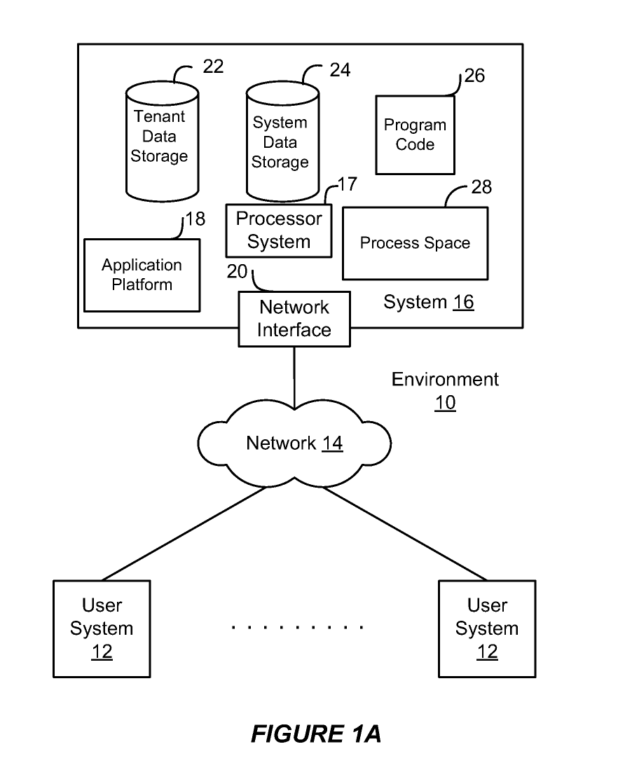

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VB Script, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

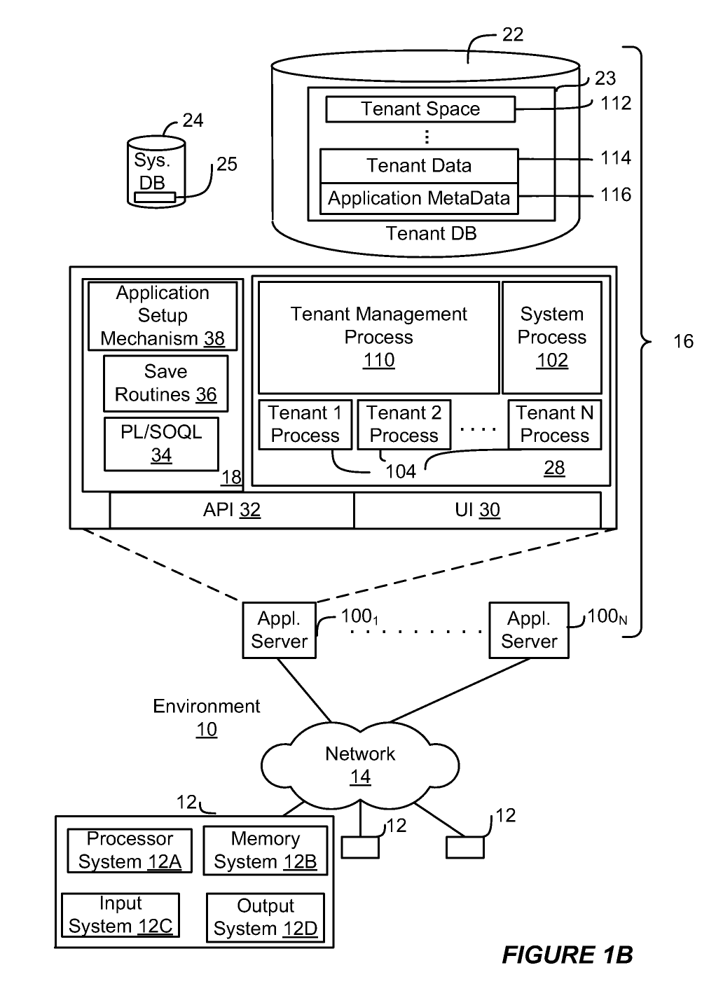

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Enterprise Social Networking

As initially described above, in some implementations, some of the methods, processes, devices and systems described herein can implement, or be used in the context of, enterprise social networking. Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). As described below, the data can include messages created by other users. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or group of users of the database system 16. Such records can include, for example, data objects representing and maintaining data for accounts, cases, opportunities, leads, files, documents, orders, pricebooks, products, solutions, reports and forecasts, among other possibilities. For example, a record can be for a business partner or potential business partner (for example, a client, vendor, distributor, etc.) of a user or a user's organization, and can include information describing an entire enterprise, subsidiaries of an enterprise, or contacts at the enterprise. As another example, a record can be a project that a user or group of users is/are working on, such as an opportunity (for example, a possible sale) with an existing partner, or a project that the user is trying to obtain. A record has data fields that are defined by the structure of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

### III. Distributed Server Architecture

The database system described above may decouple connection processing from file processing for more efficient file transfers, file updates, and file synchronization. In one example, the database system includes media servers and file servers. The media servers may take over client connection handshaking tasks typically performed by the file servers.

The media servers establish network connections with clients and receive file requests over the connections. The media servers then distribute the file requests to the file servers for further file processing, such as uploading files, downloading files, and/or syncing files. The file servers are relieved of the time consuming tasks associated with establishing network connections with clients. Thus, the file servers may have more processing bandwidth available for handling more file requests more efficiently.

The media servers, instead of the clients, may identify the file servers for servicing file requests. Thus, the media servers also relieve client devices from having to establish separate file server connections for each file request. This enables clients to send multiple file requests over the same media server connections. Thus, reducing the amount of processing bandwidth used for establishing client connections.

The database system may include a load balancer that distributes client connection requests between different media servers. The scheme used by the load balancer for selecting media servers may be independent from the scheme used by the media servers for selecting file servers. This allows the load balancer to select media servers based on available connection bandwidth while also allowing the media servers to select file servers based on their associations with particular files (file affinity).

The media servers also may detect file server failures and use a dynamic indexing scheme to automatically redistribute file requests associated with disabled file servers to operating file servers. The media servers may reassign the file requests without disturbing the files currently stored on properly operating file servers. The dynamic indexing scheme may increase overall file server reliability while reducing the number of dedicated backup servers used in the database system.

The description below refers to files, file requests, file servers, and file identifiers. However, it should be understood that the database system and the distributed server architecture describe in this application may handle any type of data request, including but not limited to, requests associated with objects, records, applications, web pages, web content, tables, feed items, audio files, video files, documents, data blocks, or the like, or any combination thereof.

The description below also may refer to connections, connection requests, handshaking, authentication, transfers, etc. In one example, the connections may include FTP file transfers sent over TCP/IP connections. However, the connections and transfers described in this application may use any protocol between user systems, clients, servers, database systems, switches, routers, or any other network elements or processing devices.

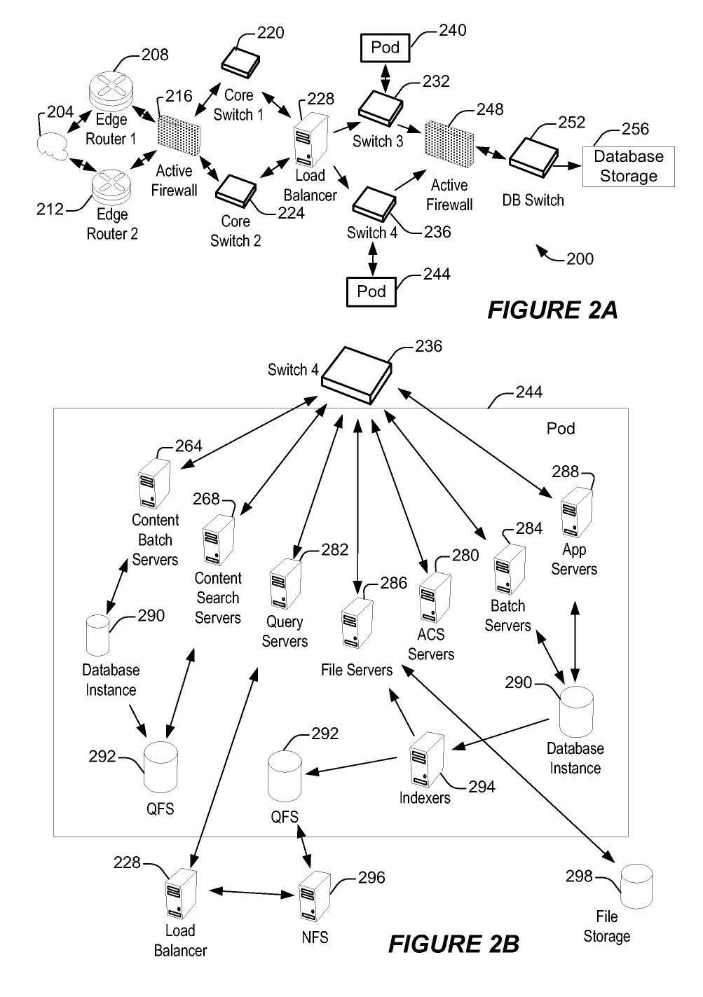

FIG. 3 shows a system diagram for an example server architecture according to some implementations. As described above and in some examples, database system 16 is alternatively referred to as a “cloud” or “cloud storage”. In some examples, database system 16 may be part of private datacenter operated by an enterprise and in other examples may be part of a public datacenter used by a variety of different enterprises and/or individuals.

Database system 16 may include one or more load balancers 312, media servers 306, and file servers 302. In one example, load balancers 312, media servers 306, and file servers 302 are connected together via LAN and/or WAN networks and include different combinations of hardware, memory, software, applications, and any other logic devices as described above.

Different user systems 12 may connect to database system 16 through a network 14 as described above in FIG. 1A. Clients 314 on user systems 12 may want to conduct file operations with database system 16. For example, a user operating user system 12A may want to upload a file from user system 12A to file database 300, download a file from file database 300 to user system 12A, synchronize files on file database 300 and user system 12A, and/or update or change files.

Client 314A may initiate a file operation by first sending a connection request 326 to an IP address associated with load balancer 312. Connection request 326 may query load balancer 312 for a media server identifier (MSID) associated with one of media servers 306. In one example, load balancer 312 may select one of the media servers 306 with a least number of existing connections 318 with clients 314. Of course, load balancer 312 may use other schemes for selecting media servers 306, such as a round robin scheme or a least recently used (LRU) scheme. Load balancer 312 sends MSID 328 back to client 314A associated with one of media servers 306, such as media server 306A. In one example, MSID 328 may comprise an IP address and/or port address for media server 306A.

Client 314A establishes one or more connections 318A with media server 306A. For example, clients 314A may conduct a handshaking and authentication protocol with media server 306A, such as FTP, HTTP, and/or TCP/IP. Of course clients 314 may use other protocols for establishing connections 318 with media servers 306 and/or database system 16.

Client 314A may send one or more file requests 322 to media server 306A over connection 318A. In some examples, file request 322 may comprise a file upload request, a file download request, a file synchronization request, a delta file synchronization request, a file update request, or any other file operation.

Media servers 306 establish connections 320 with file servers 302. In one example, connections 302 are established over a LAN or other network and may use any associated protocol such as an Ethernet protocol. Media servers 306 may maintain at least some persistent connections 320 with file servers 302 independently of file requests 322. For example, media servers 306 and files servers 302 may establish at least some connections 320 at system startup. However, media servers 306 also may add or remove some connections 320 based on the number of file requests 322 directed to particular file servers 302.

File request 322 may include a file identifier 324, such as a URL file path name. Media servers 306 may all share or use a same hash table 310. Media server 306A may hash file identifier 324 using hash table 310A to identify an associated file server 302 for servicing file request 322, such as file server 302A. Media server 306A sends file request 322 to the identified file server 302A over connection 320A.

File server 302A may search local cache 304A for a file associated with file request 322. For example, file request may 322 may request a download of file A. File server 302 may read file A from file database 300 if file A is not currently stored in cache 304A. File server 302A sends media server 306A the requested file and/or a message indicating successful completion of file request 322. Media server 306A then forwards the file and/or the message back to client 312A completing file request 322.

As mentioned above, the distributed server architecture in FIG. 3 may decouple the processing for establishing connections 318 from the processing for servicing file requests 322. For example, media servers 306 may take over responsibility from file servers 302 for connecting to clients 314. Media servers 306 then may use faster, persistent, and/or less computationally intensive connections 320 for sending file requests 322 to file servers 302. File servers 302 then may have more processing bandwidth available for servicing file requests 322.

As also mentioned above, media servers 306 may establish connections 318 with clients 314 independently of file identifiers 324 associated with file requests 322. In other words, clients 314 may no longer need to establish separate connections with file servers 302 for each file request 322. This enables clients 314 to send multiple file requests 322 associated with multiple different files over the same client connection 318.

Some systems may include a load balancer that distributes file requests to different files servers based solely on file server capacity. These systems may add additional files servers to increase overall file processing capacity. However, assigning file requests based solely on file server capacity may reduce the chances of assigning file requests to file servers that currently store the associated files in local cache memory. This may result in the file servers accessing the file database more frequently thus slowing down file operations.

As mentioned above, other systems may include clients that send file requests to file servers based solely on file identifiers associated with the file requests. However, file servers associated with popular files may quickly become overloaded with too many client connections and associated file requests also slowing down file operations.

Database system 16 may combine load balancing with file affinity based server processing. For example, load balancer 312 may assign file requests 322 to one of media servers 306 with the fewest number of connections 318 (load balancing). The selected media server 306 then may independently select one of file servers 302 for servicing file request 322 based on file identifier 324 associated with file request 322 (file affinity). File servers 302 are then more likely to receive file requests 322 for the same files and therefore are more likely to store the files in local cache memory 304. As mentioned above, load balancing and file affinity may be mutually exclusive in other server architectures.

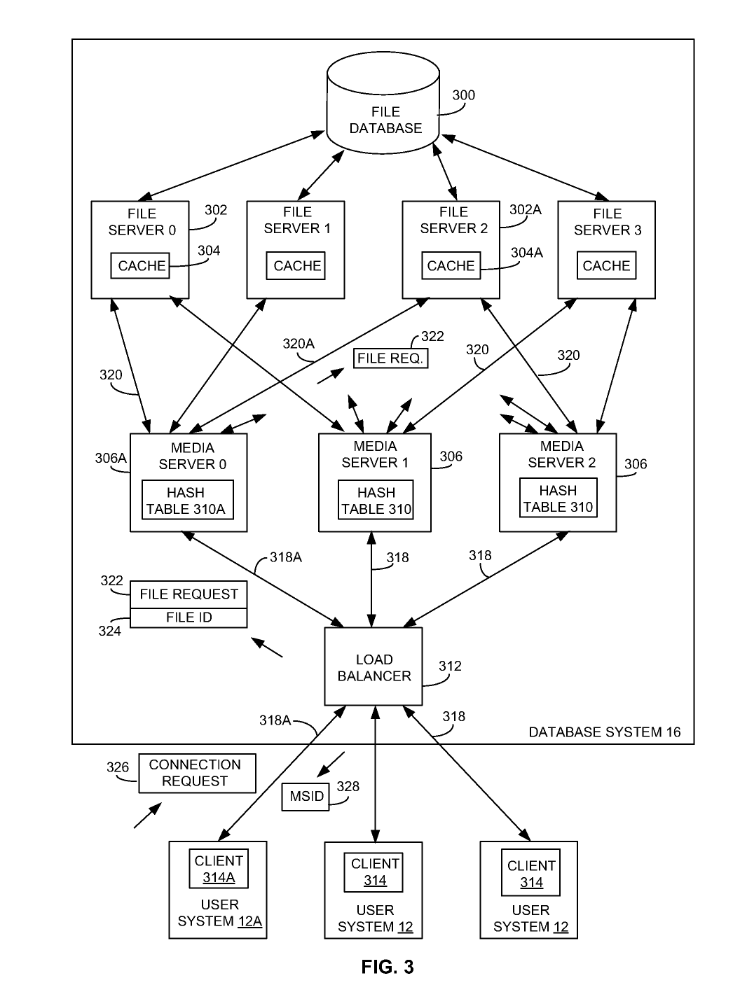

FIG. 4 shows the system diagram of FIG. 3 and example interconnections between different servers according to some implementations. As explained above, load balancer 312 may send client 312 an IP address or other identifier associated with media server 306. Client 312 establishes one or more connections 318 with the identified media server 306. For example, client 312 may send multiple TCP/IP connection requests to the IP address associated with media server 306. Media server 306 and client 312 then perform the TCP/IP handshaking that establishes one of more connections 318.

In this example, client 312 sends a first file request 322A to media server 306 over one of connections 318. For example, file request 322A may request uploading file A and include a file identifier 324A for file A. Media server 306 hashes file identifier 324A using hash table 310 and generates a first index value. In this example, the first index value is associated with file server 302A.

Media server 306 sends file request 322A to file server 302A over one of connections 320A. File server 302A may store file A in cache 304A and/or in file database 300. File server 302A may send an acknowledgement back to media server 306 over one of connections 320A confirming a successful upload of file A and media server 306 may forward the acknowledgement back to client 312 over connections 318.

Client 312 may send a second file request 322B to media server 306 over one of connections 318. In this example, file request 322B may request downloading file B. File request 322B may include a file identifier 324B, such as a URL path name for file B. Media server 306 hashes file identifier 324B using hash table 310 and generates a second index value associated with file server 302B.

Media server 306 sends file request 322B to file server 302B over one of connections 320B. File server 302B searches cache 304B for file B. If not currently stored in cache 304B, file server 302B reads file B from file database 300 and stores file B in cache 304B. File server 302B sends file B back to media server 306 over one of connections 320B and media server 306 forwards file B to client 312 over one of connections 318. Media server 306 may send and/or receive multiple file requests 322 at the same time over connections 318 and 320 further increasing file processing performance.

Media server 306 prevented client 312 from having to establish separate TCP/IP connections with file servers 302A and 302B. Media server 306 also reduced the overall number of TCP/IP connections by handling both file request 322A and file request 322B over the same connections 318.

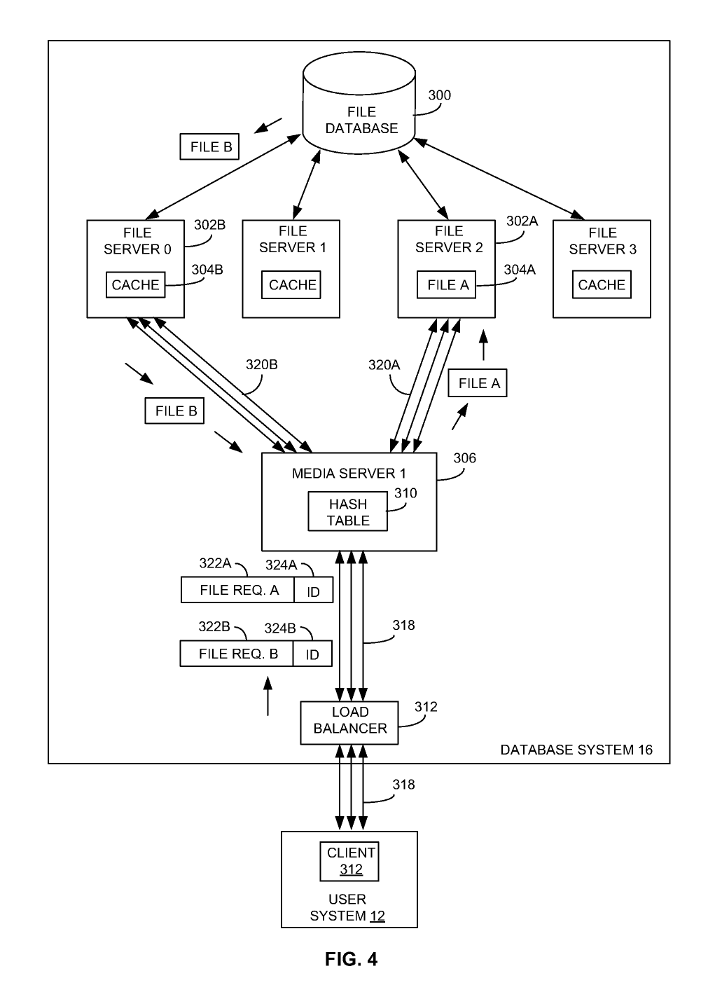

FIG. 5 shows a block diagram illustrating an example indexing scheme for identifying file servers according to some implementations. Media server 306 receives file request 322A from the client that includes file identifier 324A for file A. Media server 306 hashes file identifier 324A using hash table 310 to generate a hash value 352. In this example, the hash value=22. Media server 306 may use any type of hashing algorithm or any other function to generate numeric values from file identifier 324A, such as a message digest (MD) hash algorithm or a secure hash algorithm (SHA).

In this example, the database system includes four file servers 0, 1, 2, and 3. Of course the database system may include any number of file servers and any number of media servers. Media server 306 performs a modulo operation 354 based on the number of file servers 302. In this example, media server 306 uses a modulo 4 operation 354 corresponding with the four file servers 302 in the database system.

Modulo 4 operation 354 generates an index value 356 from hash value 352. For example, the index value for 22 MOD(4)=2. Media server 306 uses index value 356 as an index or pointer into a lookup table 358. Lookup table 358 includes multiple entries 360 each associated with a different file server 302. For example, a first entry 0 in lookup table 358 contains an address value X0 associated with file server 0. A second entry 1 in lookup table 358 contains an address value X1 associated with file server 1, etc.

Numbers in entries 360 and names of file servers 302 are shown in lookup table 358 for explanation purposes. However, lookup table 358 may only include addresses 362 stored in address locations associated with index values 356. For example, address X0 may be located in a first address location in lookup table 358 and address X1 may be located in a next sequential address location in lookup table 358, etc.

Index value=2 points to the third entry in lookup table 358 associated with file server 2. Media server 306 reads address value X2 from the third entry in lookup table 358. Media server 306 then sends file request 322A to network address X2 associated with file server 2.

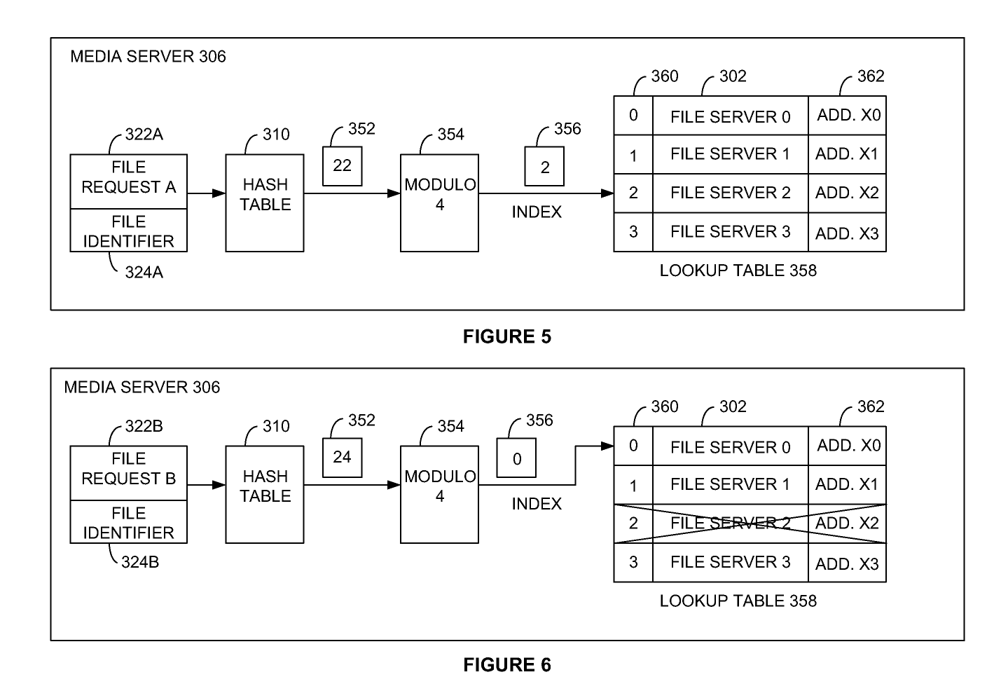

FIG. 6 shows a block diagram illustrating the example indexing scheme of FIG. 5 during a file server failure according to some implementations. In this example, a failure is detected for file server 2. For example, power, memory devices, interfaces, hardware, software, and/or network connections may prevent file server 2 from processing file requests.

During the failure of file server 2, media server 306 receives second file request 322B from the client. File request 322B includes a file identifier 324B for file B. Media server 306 hashes file identifier 324B using hash table 310 generating a second hash value 352. In this example, the second hash value=24.

Media server 306 performs another modulo 4 operation 354 on hash value=24 generating an index value=0. Media server 306 uses index value=0 as an index or pointer into lookup table 358 identifying address value X0 associated with file server 0.

File server 0 is not affected by the failure of file server 2 and media server 306 continues using the same indexing scheme and lookup table 358 used above in FIG. 5. For example, media server 306 reads address X0 from lookup table 358 and sends file request 322B to address X0 associated with file server 0.

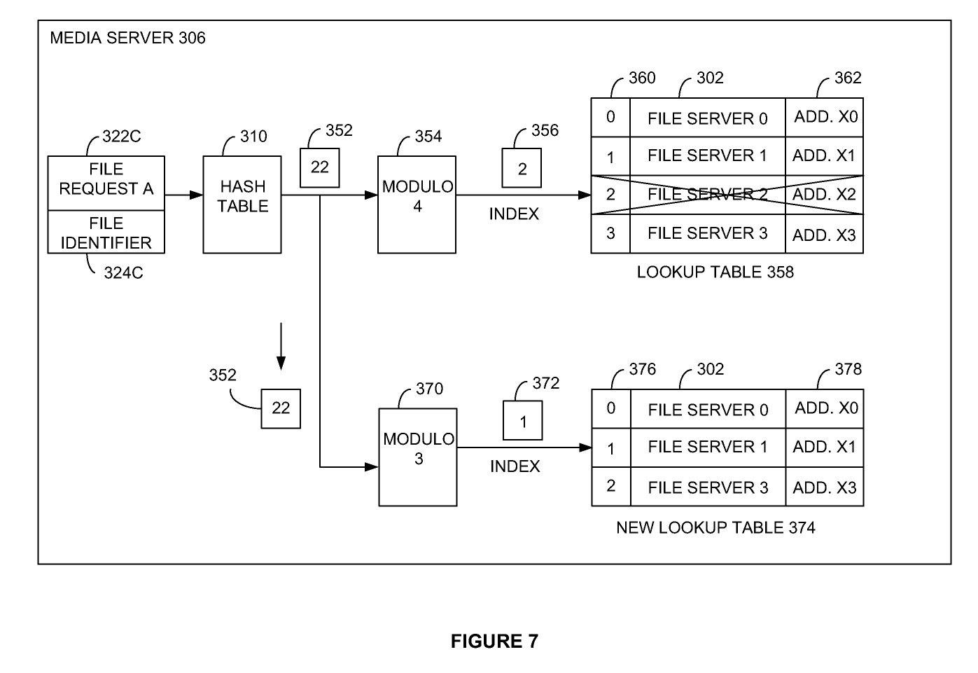

FIG. 7 shows a block diagram illustrating another example of the indexing scheme of FIG. 5 during a file server failure according to some implementations. In this example, the failure still exists on file server 2. Media server 306 receives another file request 322C again associated with file A. Media server 306 hashes file identifier 324C using hash table 310. In this example, file identifier 324C has the same file path name as file identifier 324A in FIG. 5 and hash table 310 accordingly generates the same hash value=22.

Media server 306 performs the same modulo 4 operation 354 on hash value=22 generating the same index value 22 Mod (4)=2 as previously generated in FIG. 5. Media server 306 uses index value=2 as a pointer into lookup table 358 identifying address value X2 for file server 2. However in this example, media server 306 determines address X2 is associated with disabled file server 2. Media server 306 may detect the failure of file server 2 either by unsuccessfully sending file request 322C to file server 2 or by previously receiving a failure message from the database system indicating file server 2 is no longer operational.

Media server 306 may send a message back to the client directing the client to re-synchronize, re-upload, re-download, or re-update file A. Alternatively, or in addition, media server 306 may continue processing file request 322C. Either way, media server 306 may dynamically adjusts the indexing scheme in response the failure of file server 2.

Media server 306 first may create a new lookup table 374 that does not include an entry for disabled file server 2. For example, three file servers 0, 1, and 3 still remain operational in the database system. Media server 306 configures new lookup table 374 to include three entries 376 for file servers 0, 1, and 3. For example, media server 306 generates new lookup table 374 by replacing the third entry in lookup table 358 with address X3 for file server 3.

Media server 306 also may perform a new modulo 3 operation 370 corresponding with the remaining three file server entries in lookup table 374. For example, operation 370 performs a MOD(3) operation on hash value=22 generating index value=1. Index value=1 points to address X1 in new lookup table 374 associated with file server 1. Media server 306 then sends file request 322C to address X1 for file server 1.

File server 2 may have previously stored file A in local cache memory. File server 1 was not previously associated with file A. Depending on the operation associated with file request 322C, file server 1 may load file A into local cache memory 304 and file database 300 (see FIG. 4). If file request 322C is a file download, file server 1 may first download file A from file database 300 into cache memory 304. File server 1 may execute file request 322C for file A and send results through media server 306 back to the client.

Media server 306 dynamically adjusts the indexing scheme in response to file server failures. For example, media server 306 evenly redistributes file requests 322 and associated files associated with disabled file servers across the remaining operational file servers as shown in FIG. 7. However, media server 306 might also provide the additional advantage of not adjusting the indexing scheme or changing associations for files currently stored on operational file servers.

Some database systems may provide separate backup file servers for each primary operating file server. The database system may activate the backup file server when a failure is detected on the associated primary file server. Media server 306 may dynamically redirect file requests to other operating file servers thus reducing the number of separate backup file servers used by the database system.

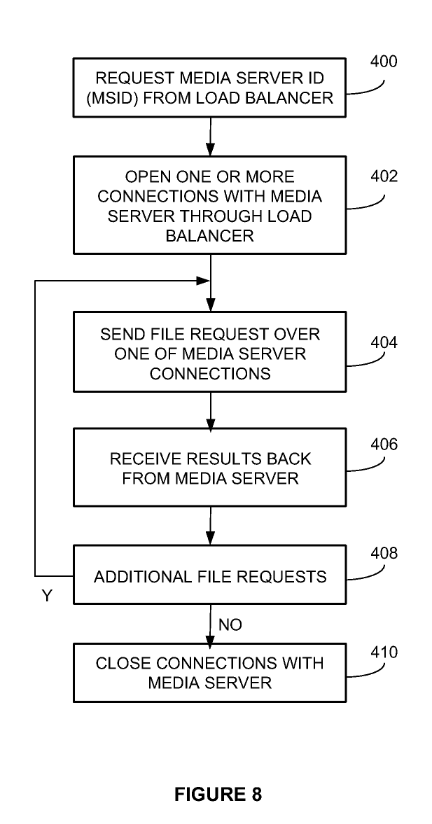

FIG. 8 shows an example operational flow diagram illustrating a client technique for sending file requests according to some implementations. In operation 400, the client may send a request to the load balancer for a media server. For example, the client may request the load balancer to provide a media server identifier (MSID), such as an IP address.

In operation 402, the client receives the MSID back from the load balancer and opens one or more connections with the identified media server. For example, the client may open one of more TCP/IP connections with the identified media server.

In operation 404, the client sends a file request over the connections established with the media server. For example, the client may comprise an FTP client that sends FTP commands to the media server requesting a file upload. In operation 406, the client receives results of the file request back from the media server. For example, the client may receive a file back from the media server in response to a file download request or may receive a message back from the media server in response to a successful file upload request.

In operation 408, the client may send other file requests to the media server over the same established connections. For example, the client may want to upload another file or synchronize a previously uploaded file. In operation 404, the client sends another file request over the previously established connections with the media server and in operation 406 the client receives the results from the second file request back from the media server. The client may repeat operations 404 and 406 for any number of file requests. After completing all file requests in operation 408, the client may close the connections with the media server in operation 410.

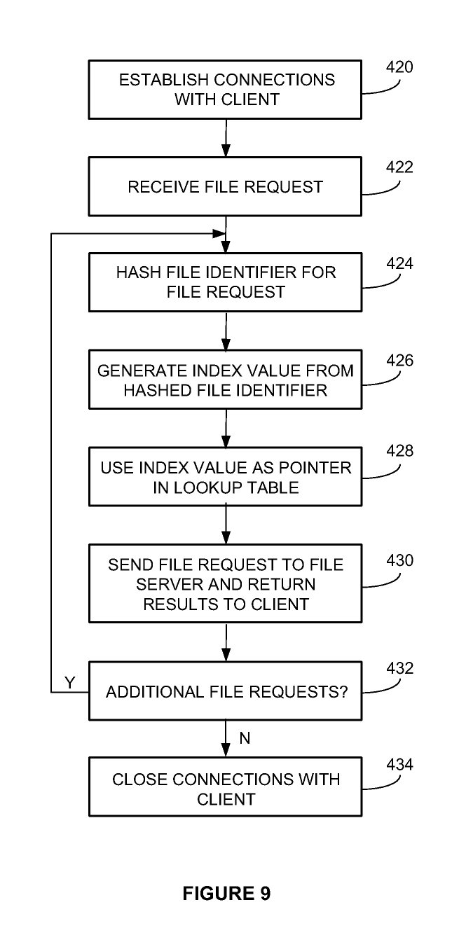

FIG. 9 shows an operational flow diagram illustrating an example media server technique for processing file requests according to some implementations. In operation 420, the media server establishes one or more connections with the client. For example, the media server exchanges FTP and TCP/IP handshaking messages with the client to establish the connections. In operation 422, the media server receives a file request over the connections.

In operation 424, the media server hashes the file identifier associated with the file request. In operation 426, the media server generates an index value from the hash value. For example, the media server uses a modulo operation associated with the number of file servers.

In operation 428, the media server uses the index value as a pointer into a lookup table. For example, the index value identifies an address in the lookup table associated with one of the file servers. In operation 430, the media server sends the file request to the identified file server. For example, the media server may send the file request to the IP address identified in the lookup table.

The media servers may maintain connections with each of the file servers and may send file requests over the previously established connections. For example, each media server may maintain a pool of connections to each of the file servers and reuse the connections for file requests received from different clients. In another example, the media server may establish some or all of the file server connections in response to the file requests and the associated file servers identified in operation 428.

In operation 432, the media server monitors for additional file requests from the client. If other file requests are received, the media server identifies an associated file server in operations 424-428 and sends the file request to the identified file server address in operation 430. The media server may continue to monitor for file requests until the connections with the client are closed in operation 434. For example, the client may close the TCP/IP connections with the media server after completing all of the desired file requests.

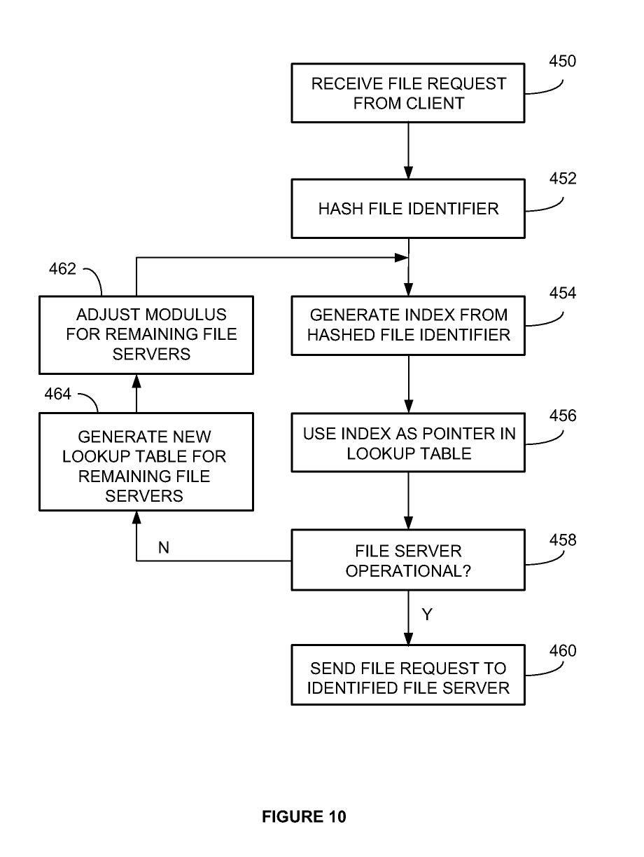

FIG. 10 shows an operational flow diagram illustrating another example media server technique for processing file requests according to some implementations. In operation 450, the media server receives a file request from a client. In operation 452, the media server hashes the file identifier associated with the file request. In operation, 454, the media server generates an index value from the hash file identifier. For example, the media server performs a modulo operation based on the number of file servers.

In operation 456, the media server uses the index value as a pointer into the lookup table to identify an associated one of the file servers. If the identified one of the file servers is operational in operation 458, the media server sends the file request to the identified file server in operation 460.

If the identified file server is not operational in operation 458, the media server in operation 464 generates a new lookup table based on the remaining operational file servers. For example, the media server generates a new lookup table that only includes entries for the other remaining file servers. In operation 462, the media server adjusts the modulo used for generating the index value based on the number of entries in the new lookup table. For example, the number of operational file servers may change from four to three. In operation 462, the media server changes the previous modulo 4 operation to a modulo 3 operation.

The media server then uses the new lookup table and new modulo in operations 454 and 456 to identify another file server for sending the file request. The media server repeats operations 464 and 462 each time the identified file server is determined to be non-operational in operation 458. The media server reverts back to the original lookup table and original modulo for new file requests received in operation 450. This allows properly operating file servers to maintain existing files in local cache memory thus reducing accesses to the file database.

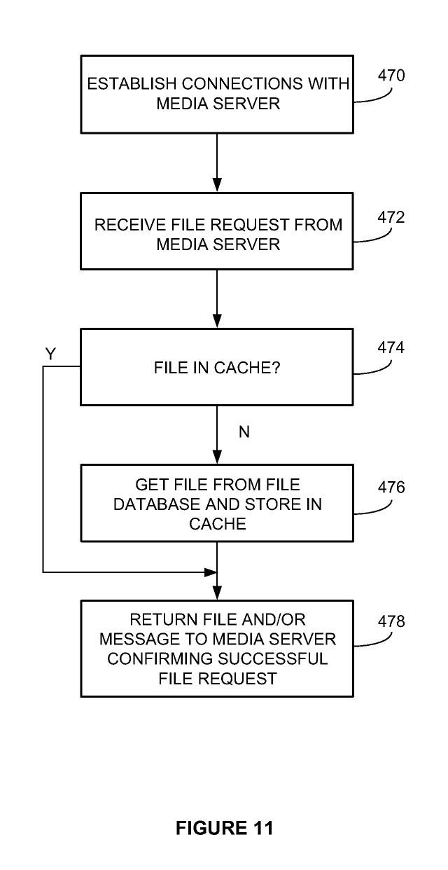

FIG. 11 shows an operational flow diagram illustrating an example file server technique for processing file requests according to some implementations. In operation 470, the file server establishes one or more connections with the media servers. As explained above, the file servers and media servers may maintain persistent connections independently of the file requests. In one example, some connections between clients and servers may be established using schemes described in U.S. patent application Ser. No. 13/648,777, entitled SLIPSTREAM BANDWIDTH MANAGEMENT ALGORITHM, by Barry Spencer, filed Oct. 10, 2012, Attorney Docket No. 8956P091 (783USUS) which has been incorporated by reference in its entirety.

In operation 472, the file server receives a file request from the media server. For example, the file request may request a download of a particular file. In operation 474, the file server checks local cache for the file. If the file is stored in local cache, the file server returns the file to the media server in operation 478. If not located in cache, the file server may read the file from the file database in operation 476. The file server stores the file in local cache and sends the file to the media server in operation 478.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer program stored on a tangible medium for a database system, with the database system including a media server and file servers, the computer program comprising a set of instructions operable to:
establish, at the media server, a network connection with a client on a remote user platform;
receive, by the media server, a file request over the network connection;
determine, by the media server, a file identifier for the file request;
select, by the media server, one of the file servers associated with the file identifier; and
send, by the media server, the file request to the selected one of the file servers associated with the file identifier.

2. The computer program of claim 1, including instructions operable to:
receive, by the media server, a second file request over the same network connection;
determine, by the media server, a second file identifier for the second file request;
select, by the media server, a second one of the file servers associated with the second file identifier; and
send, by the media server, the second file request to the second one of the file servers associated with the second file identifier.

3. The computer program of claim 1, including instructions operable to:
generate, by the media server, an index value from the file identifier;
apply, by the media server, the index value to a lookup table to determine an address for the selected one of the file servers; and
send, by the media server, the file request to the address for the selected one of the file servers.

4. The computer program of claim 3, including instructions operable to:
detect, by the media server, a failure for the selected one of the file servers;
generate, by the media server, a modified lookup table that excludes the address for the selected one of the file servers;
apply, by the media server, the index value to the modified lookup table to determine a different address for a different one of the file servers; and
send, by the media server, the file request to the different address for the different one of the file servers.

5. The computer program of claim 3, including instructions operable to:
apply, by the media server, a hashing algorithm to the file identifier to generate a hash value; and
generate, by the media server, the index value from the hash value.

6. The computer program of claim 5, including instructions operable to:
perform, by the media server, a modulo operation on the hash value; and
use, by the media server, a result of the modulo operation as the index value.

7. The computer program of claim 6, including instructions operable to:
identify, by the media server, a number of the file servers operating in the database system; and
adjust, by the media server, a modulo value used in the modulo operation based on the number of the file servers operating in the database system.

8. The computer program of claim 1, wherein the database system includes a load balancer and the media server receives a request from the client through the load balancer to establish the network connection based on a number of previously established connections on the media server.

9. The computer program of claim 1, including instructions operable to:
establish, at the media server, multiple transmission control protocol/internet protocol (TCP/IP) network connections with the client, with the network connection being one of the TCP/IP connections;
receive, by the media server, multiple file transport protocol (FTP) requests over the TCP/IP network connections, with the file request being one of the multiple FTP requests; and
distributing, by the media server, the FTP requests to the file servers based on file path names identified in the FTP requests, with the file identifier being one of the file path names.

10. A method for processing file requests in a database system including a media server and file servers, comprising:
receiving, by the media server, a connection request from a client operating on a remote user platform;
establishing, by the media server, a connection with the client;
receiving, by the media server, multiple file requests over the connection with the client;
identifying, by the media server, file servers in the database system associated with files identified in the file requests; and
sending, by the media server, the file requests to the identified file servers.

11. The method of claim 10, wherein the media server receives the connection request based on a number of previously established connections on the media server.

12. The method of claim 10 further comprising receiving, by the media server, the connection request through a load balancer operating within the database system.

13. The method of claim 10, further comprising:
receiving, by the media server, a first one of the file requests over the connection, the first one of the file requests associated with a first one of the files;
identifying, by the media server, a first one of the file servers associated with the first one of the files;
sending, by the media server, the first one of the file requests to the first one of the file servers;
receiving, by the media server, a second one of the file requests over the connection, the second one of the file requests associated with a second one of the files;
identifying, by the media server, a second one of the file servers associated with the second one of the files;
sending, by the media server, the second one of the file requests to the second one of the file servers.

14. The method of claim 10, further comprising:
identifying, by the media server, file identifiers associated with the file requests;
generating, by the media server, index values from the file identifiers; and
identifying, by the media server, the file servers for processing the file requests based on address values in a lookup table referenced by the index values.

15. The method of claim 10, further comprising:
identifying, by the media server, a file identifier associated with a received one of the file requests;
generating, by the media server, a first index value from the file identifier based on a number of address entries in a first lookup table;
using, by the media server, the first index value to identify a first address in the first lookup table associated with a first one of the file servers;
determining, by the media server, the first one of the file servers is disabled;
generating, by the media server, a second lookup table that excludes the first address associated with the first one of the file servers;
generating, by the media server, a second index value from the file identifier based on a number of address entries in the second lookup table;
using, by the media server, the second index value to identify a second address in the second lookup table associated with a second one of the file servers; and
sending, by the media server, the received one of the file requests to the second address associated with the second one of the file servers.

16. The method of claim 15, further comprising:
identifying, by the media server, a next file identifier associated with a next received one of the file requests;
generating, by the media server, a third index value from the next file identifier based on the number of address entries in the first lookup table;
using, by the media server, the third index value to identify a third address in the first lookup table associated with a third one of the file servers;
determining, by the media server, the third one of the file servers as operational; and
sending, by the media server, the next received one of the file requests to the third address associated with the third one of the file servers.

17. The method of claim 10, further comprising:
identifying, by the media server, file identifiers associated with the file requests;
applying, by the media server, a hash algorithm to the file identifiers to generate hash values;
applying, by the media server, a modulo algorithm to the hash values to generate index values; and
use, by the media server, the index values to identify address values in a lookup table associated with the file servers.

18. A database system, comprising:
a processing system; and
a memory device coupled to the processing system, the memory device having instructions stored thereon that, in response to execution by the processing system, cause the processing system to perform operations comprising:
establishing a network connection with a client operating on a remote user platform;
receiving a data transaction request over the network connection;
determining an identifier associated with the data transaction request;
generating an index value based on the identifier;
using the index value to identify an address in a lookup table;
sending the data transaction request to a server in the database system associated with the address;
receiving results of the data transaction request back from the server in the database system; and
forwarding the results to the client operating on the remote user platform.

19. The database system of claim 18, wherein the operations further comprise:
applying a hash algorithm to the identifier to generate a hash value; and
generating the index value based on a modulo of the hash value.

20. The database system of claim 18, wherein the operations further comprise:
detecting a failure of the server associated with the address;
generating a modified lookup table that excludes the address associated with server;
generating a different index value based on a number of entries in the modified lookup table;
using the different index value to identify a different address in the modified lookup table; and
sending the data transaction request to a different server in the database system associated with the different address for processing the data transaction request.
